(19) United States
(12) Patent Application Publication
(10) Pub. No.: US 2008/0134988 A1
(43) Pub. Date: Jun. 12, 2008

(54) Method of deterring domestic pets from indiscriminate soiling in areas in a house and means for effecting the same

(76) Inventor: Carolyn Lee Dorman, Potomac Falls, VA (US)

Correspondence Address: MERCHANT & GOULD PC, P.O. BOX 2903, MINNEAPOLIS, MN, 55402-0903, US

(21) Appl. No.: 11/637,182

(22) Filed: Dec. 12, 2006

(51) Int. Cl. A01K 15/04; A01K 15/02

(52) U.S. Cl. 119/719; 119/712; 119/720; 119/721

(57) ABSTRACT

A means for deterring a household pet from soiling an area of a residence, which comprises two or more motion detection means in operable connection with each other, and reporting means, whereby said two or more motion detection means are activated by motion of the household pet within detection range of the two or more detection means, said reporting means alarming the household pet, whereby the pet departs an area proximate to the deterring means.

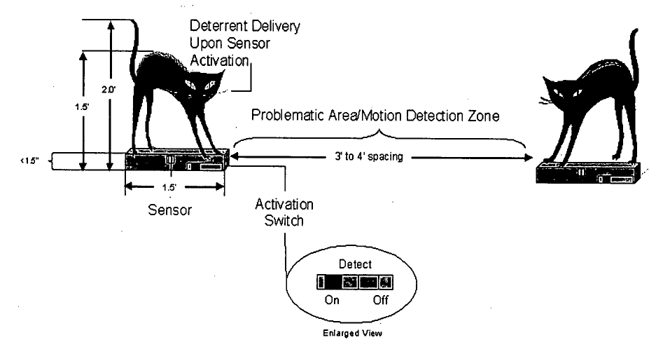

### FIELD OF THE INVENTION

The present invention relates to a method of deterring domestic pets from indiscriminate soiling in unwanted areas in a residence, and a means for effecting such deterrence.

### BACKGROUND OF THE INVENTION

Indiscriminate pet elimination is a common behavioral complaint of pet owners. Examples of such indiscriminate behavior are urine and/or stool depositions outside of a litter box, or marking behaviors such as spraying or horizontal urination in small amounts by cats.

It is known that urinary tract infections and diseases in household pets can cause indiscriminate elimination. For example, stones and crystal formation in the bladder, bacterial infections, and a group of inflammatory diseases of the bladder and urinary tract of unknown origin cause pain and an increased urgency to urinate. Also, diseases of the kidneys and liver can cause a pet to drink more and, thus, urinate more frequently. Age-related cognitive (brain function) decline and endocrine disorders such as hyperthyroidism and diabetes, can lead to changes in elimination habits including house-soiling. Medical problems that also give rise to a difficulty or discomfort in passing stools, poor control or an increased frequency of defecation could all contribute to house-soiling with stools. Colitis, constipation, and anal sac diseases in cats, for example, are just a few of the medical problems that need to be considered when diagnosing the cause of inappropriate defecation. Another consideration is the pet's mobility and sensory function. Medical conditions affecting the nerves, muscles, or joints, could lead to enough discomfort, stiffness or weakness that the cat may not be able to get to the litterbox, climb into the litterbox, or get into a comfortable position for elimination.

Thus, if elimination is associated with pain or discomfort, or if access to a litterbox is difficult or uncomfortable, a cat may begin to eliminate outside of its litter box. Cats having an increased frequency of elimination and those with decreased control may begin to soil the house.

However, a cat may not use the litter box if it prefers another location. If soiling is always found in one place, this indicates a location preference, while elimination on one particular surface type or texture (such as carpeting or tiled floors), indicates a substrate preference. If this occurs in only one or two places, the cat can be prevented from being in that location without supervision. When no one is home, or is asleep, the cat may need to be confined. If the owner is at home, it is necessary to know where the pet is. This can be accomplished by watching the pet or by using a bell on an approved pet collar or a leash and harness. If a cat does not like where the litter box is due to disruptions in that location, moving the box to a quieter, more secure location may also aid in getting the cat to return to regular litter box usage. The surface can be made less appealing by changing the surface texture (remove the carpeting), or by making the surface uncomfortable (double-sided sticky tape, a plastic carpet runner with nubs up, remote punishment or booby-traps). In some cases, access to the area can be permanently prevented by closing off doors to the area, by putting up barricades, or confining the cat away from the problem area. The appeal of the surface can also be reduced by eliminating all odors that might be attracting the cat back to the area by cleaning and then by applying odor neutralizers. Sometimes changing the function of the area by turning it into a feeding, playing, sleeping or scratching area may reduce the cat's desire to eliminate in the area.

Other types of pets, such as puppies also may present indiscriminate soiling problems. This may be caused by diverse reasons. For example, the puppy may not be properly trained, or under stress due to being left alone. Also, older dogs may engage in either scent marking or may use soiling as a means to get attention.

Similar problems can also exist with pets such as ferrets, guinea pigs or rabbits. Ferrets may be particularly troublesome for although they can be housetrained, they do have a very short intestine and, thus, eliminate more frequently than other types of pets.

Yet, even after making a litter area more appealing, decreasing the appeal of the soiled areas, and perhaps administering anti-anxiety drugs for anxiety induced or marking problems, the habit may persist. Moreover, in an age where more persons are away from home for longer periods of time, it is often impractical to constantly monitor a pet's elimination behavior.

Drug therapy can be a helpful adjunct where stress, anxiety, marking or a medical component is involved. It requires a thorough understanding of the indications, contraindications and potential side-effects of the various drugs. An accurate diagnosis is needed to determine if such therapy will be helpful and which drug to choose. If the behavior is due to a surface substrate preference, location preference or any type of aversion, drug therapy is unlikely to be helpful. Commonly used drugs include buspirone, anti-depressants, and benzodiazepines.

However, it would be advantageous to avoid drug therapies in deterring household pets, for example cats, from littering the home outside of a litter box. It would also be advantageous to provide a means by which indiscriminate pet elimination could be eliminated without the need for constant supervision.

### SUMMARY OF THE INVENTION

Accordingly, it is an object of the present invention to provide a method for deterring household pets from littering in areas within a residence other than in a litter box.

It is, moreover, an object of the present invention to provide a system for effecting the above method.

It is also an object of the present invention to provide a method for detecting and reporting motion by a household pet, and deterring further approach of the pet to an area within a residence.

It is, further, an object of the present invention to provide a system for effecting this method of pet deterrence.

The above objects and others are provided by a system for deterring a household pet from indiscriminate soiling in a residence, which contains at least two motion detection and reporting means.

### BRIEF DESCRIPTION OF THE DRAWING

The drawing depicts an example of a device of the present invention. The device includes two mechanical cats each having a motion sensor, and each being positioned at an edge of a problem area, where the pet frequents for indiscriminate elimination. Each sensor has an activation switch.

### DETAILED DESCRIPTION OF THE PREFERRED EMBODIMENTS

The present invention provides a safe, chemical free, portable and low cost/low maintenance approach to deterring domestic household pets, such as dogs, cats, hamsters, ferrets, guinea pigs or even hamsters from urinating and/or excreting in undesirable areas within a residence.

In general, the present invention provides a method for deterring household pets from littering or soiling an area of a residence where such littering or soiling is not desired. The present invention is particularly advantageous with cats.

Further, the above method is generally effected by at least two motion detection and reporting means, and, preferably, where a motion detection and reporting means are consolidated in a single object.

As used herein, the following definitions apply:

1) “littering or soiling” means either urinating or defecating or both;

2) “residence” means a residential house or commercial building space and any area containing human occupants, where a domestic pet may be kept.

3) “domestic pet” means any animal that may be kept as a household pet, such as dogs, cats, mice, hamsters, ferrets, guinea pigs, mice or minks. The present invention is particularly advantageous with domestic cats, however.

4) “indiscriminate soiling” means urinating an/or defecating in unwarranted areas of a residence, i.e., any areas other than a designated area, such as a litter box.

5) “problematic area” means an undesirable area of a residence within which a household pet litters or soils.

6) “system” means a combination of motion sensor-reporting devices arranged at the outer perimeter of a problematic area so as to effectively repel a pet from the area when activated.

The present invention provides means for deterring a pet from indiscriminate soiling which contains at least two motion detection and reporting means which are set apart with a distance therebetween. The motion detection zone typically spans no less than about two feet and no more than about five feet so as when a motion sensor is tripped by a pet's movement a reporting means is then activated, which may be motion, lights, and/or sound. The sequence lasts for approximately 30 seconds in which the pet hurriedly exits the area. Over time, this process of deterrence motivates the pet to stay out of the area.

As used herein, the term “pet detection sensor” means any device which detects motion or body heat. For example, the pet detector may be a microwave motion detector. See U.S. Pat. No. 5,481,266, which is incorporated by reference herein in the entirety. It also may be an infrared sensor. See U.S. Pat. Nos. 5,345,238; 6,359,276 and 6,793,389, all of which are incorporated herein in the entirety.

As used herein, the term “reporting means” means any device which emits an auditory or visual response to the pet detector. Preferably, the reporting means uses both responses, i.e., both visual and auditory.

Any audible reporting means may be used including those emitting a repelling high frequency sound, human voice or music. See, for example, U.S. Pat. Nos. 6,966,840 and 6,784,798, both of which are incorporated herein in the entirety. As noted above, however, it is preferred that the reporting means include both visual and audible means.

As a visual reporting means, it is preferred that one or more moving objects be used such as faux posts, tombstones or animals. When faux (false or imitation) animals are used, it is preferred that the faux animal used be the same as the real animal being repelled. It is most preferred that a combination of at least two faux animals emitting sound be used, such as cats which move when prompted by one or more motion detectors. The movement of the cat may include tail motion, head motion and even a back-arching motion. The emitting sound may be meowing, hissing, singing with a human voice or music. Preferably, a single motion sensor and reporting means are within the same object, such as a tombstone or faux animal, such as a cat, for example.

The combination of the two sensors working in unison provides redundancy/reinforcement influencing the cat's behavior to vacate the immediate area. This in turn, causes the cat to flee to more familiar, quiet and acceptable territories for them to excrete their waste. Employing this approach (that is, a tripped and repeated deterrent) typically after one to two months will modify the cat's behavior as to not return to the problematic area.

The device of the present invention is advantageous for a number of reasons, such as low cost and portability. Further, however, the present device is also advantageous as it can function to effectively deter household pets from relatively large areas. This is in contrast to U.S. Pat. No. 6,860,239, the device of which relies upon the conductivity of urine to complete a circuit in order to prompt an alarm. This prior art device, of course, also uses a “post-event” approach, which the present invention seeks to avoid.

It is advantageous that the problematic area be treated prior to placement of the present device by pouring baking powder on subject area 24 hours and subsequent vacuuming before use of the device. This pre-treatment will lessen the odorant of previous cat excretions and thus the desire for the cat to excrete in the area.

As noted above, an exemplary deterring means is a battery operated device containing two or more motion sensor devices resembling creatures in which pets have a tendency to flee and/or feel antagonist toward. Preferably, the device contains two life-like cats, dogs, other animals, or any combination thereto. Each motion sensor device resembles the actual size of the life-like animal and is typically an approximate size or larger of the cat or dog, for example, and having attributes (such as fake fur and respective motion) of the animal in which the device resembles. The material composition of the detection device base is a low cost polymer/plastic with a simple switch having options for ON, DETECT, and OFF, seconds in which the house cat hurriedly exits the immediate area and over time influences the cat's behavior to stay out of that area.

Battery-powered motion sensors are well known. See, for example, U.S. Pat. Nos. 5,790,040; 7,123,139 and 4,319,228, each of which is incorporated herein in the entirety.

The faux animals are constructed such that the motion sensor, once activated, triggers either a sound or motion response in the animal, such as a cat, for example, and preferably both.

Having described the present invention, reference will now be made to exemplary equipment and an example, which are provided solely for purposes of illustration and which are not intended to be limitative.

### Exemplary Equipment:

The device may contain the following equipment:
Two motion detection units resembling life-like animals such as a cat and/or dog.
   Dog units will (when activated with motion) simultaneously flap its ears, howl, bark, and make movements as if it were sitting and then standing—an approximated three cycles lasting a total of 30 seconds.
   Cat units will (when activated with motion) meow, make hissing sounds, arch its back, and sing a jingle—with about three cycles or more lasting a total of 30 seconds each.

### Interconnection:

No interconnection is required between the two motion sensors other than an approximated three to four foot separation in which the two motion sensors face one another. Low vault COTS batteries are required to power for each unit.

The present invention will now be further described by reference to an Example which is provided solely for purposes of illustration and is not intended to be limitative.

### EXAMPLE

The example uses two battery-operated motion sensors: (1) a black furred cat with arching back and dancing movements, flashing green eyes and which howls and sings when activated by the movement of the house cat attempting to excrete in the forbidden area; and (2) two foot by one foot tombstone that flashes red lights, flapping tombstone movement that exposes a dancing skeleton making ghoulish sounds. With correct placement, the black cat is activated by a house cat followed by tombstone movement which is activated by the black cat's (1) movement. The sequence lasts for approximately 30 seconds, more than sufficient to deter a cat. See the drawing.

The drawing will now be described in detail. The drawing shows two motion detection and reporting means in the form of two cats. That is, each cat contains both a motion detection sensor and reporting device. The cats are set at the outer edge of a problem area for littering and/or soiling. Each cat can, for example, be purchased at Walgreen's. Such cats are produced by Gemmy Industries, Inc. The on/off switch of each cat may be activated with a motion sensor which then triggers the cat response of an arching back, hissing noise and a jingle. The use of motion sensors to activate an on/off switch are well-known with lights triggered by motion, for example.

Other types of reporting means may include a tombstone which exposes a dancing skeleton and/or a light when activated, for example. The tombstone may either be a primary motion sensor, i.e., being directly activated by animal, or the tombstone may be a secondary motion sensor, i.e., being activated by one or both of the faux animals and their motion, which have been directly activated by the animal. See, example, U.S. Pat. Nos. 5,911,617 and 6,524,158.

Finally, reporting means may be selected based upon seasonal considerations. As examples of “seasonal reporting means,” the following may be noted: spring (a rabbit), summer (a U.S. flag), autumn (a pumpkin or Halloween cat) and winter (a holiday tree or menorah). Hence, the device of the present invention may be used in a festive manner as well as a purely functional manner. The variation of light and sound, noted above, applies to each of these objects as well. Thus, for example, the present invention specifically contemplates pumpkins, blinking holiday trees, jumping rabbits and/or waving flags. All may be used to equal effect in discouraging a household pet from unwanted soiling or littering in a problematic area of a residence.

Thus, the following table describes several exemplary combinations of motion sensor-reporting devices which may be used in the present deterrence system.

| | | motion | |
|---|---|---|---|
| | motion sensor- | sensor-reporting | motion sensor- |
| system # | reporting device #1 | device #2 | reporting device #3 |
| 1 | cat | tombstone with | — |
| | | dancing skeleton | |
| 2 | rabbit | cat | tombstone with |
| | | | dancing skeleton |
| 3 | cat | cat | — |
| 4 | U.S. flag | cat | tombstone with |
| | | | dancing skeleton |
| 5 | holiday tree | cat | cat |

The above specification, examples and data provide a complete description of the manufacture and use of the composition of the invention.

It will be understood that many changes and modifications may be made to the above-described embodiments without departing from the spirit and the scope of the present invention.

What is claimed is:

1. A system for deterring a household pet from unwanted soiling or littering of an area of a residence, which comprises at least two motion sensor means and reporting means, configured to be activated by a household pet, thereby alarming the household pet.

2. The system of claim 1, wherein the at least two motion sensor means and reporting means are embodied in two faux animals, each having a single motion sensor and reporting means.

3. The system of claim 1, wherein the motion sensors are battery-operated.

4. The system of claim 1, wherein the at least two motion sensors are infrared sensors.

5. The system of claim 3, wherein the reporting means comprises both sound and motion.

6. The system of claim 5, which further comprises a light which flashes.

7. The system of claim 6, wherein the light is affixed to a tombstone which exposes a dancing skeleton.

8. The system of claim 1, wherein the at least two motion sensor means are a tombstone and a cat.

9. The system of claim 1, wherein the at least two motion sensor means are a tombstone and two cats.

10. A method for deterring a household pet from unwanted soiling or littering of an area in a residence, which comprises the steps of:
a) placing at least one two motion sensor means and reporting means at a location in the residence to deter the pet from indiscriminate soiling at that location;
b) detecting the pet when the pet approaches the location, by the at least two motion sensors means, and
c) deterring the pet by reporting means activated by the at least two motion sensor means.
